(19) United States
(12) Patent Application Publication
(10) Pub. No.: US 2003/0154158 A1
(43) Pub. Date: Aug. 14, 2003

(54) Multi-mechanism order processing

(76) Inventors: Peter J. Martyn, Ridgewood, NJ (US); Natalya Okunev, Brooklyn, NY (US)

Correspondence Address: DENIS G. MALONEY, Fish & Richardson P.C., 225 Franklin Street, Boston, MA, 02110-2804, US

(21) Appl. No.: 10/294,459

(22) Filed: Nov. 14, 2002

Related U.S. Application Data
(60) Provisional application No. 60/335,388, filed on Nov. 14, 2001.
(60) Provisional application No. 60/385,979, filed on Jun. 5, 2002.
(60) Provisional application No. 60/385,988, filed on Jun. 5, 2002.

(51) Int. Cl. G06F 17/60

(52) U.S. Cl. 705/37

(57) ABSTRACT

A multi-mechanism order scanning process includes a first interface process for monitoring the trading activity of securities traded on a first trading platform. A second interface process monitors the trading activity of securities traded on a second trading platform. A summarized display process, which is responsive to the first and second interface processes, provides a summarized display that itemizes at least a portion of the trading activity monitored on the first and second trading platforms.

### RELATED APPLICATIONS

This application claims the priority of: U.S. Provisional Patent Application No. 60/335,388, entitled “Super Montage”, and filed on Nov. 14, 2001; U.S. Provisional Patent Application No. 60/385,979, entitled “Supermontage Architecture”, and filed on Jun. 5, 2002; and U.S. Provisional Patent Application No. 60/385,988, entitled “Security Processor”, and filed on Jun. 5, 2002.

### BACKGROUND

This invention relates to electronic securities trading, and the processing and displaying of information relating to electronic securities trading.

Electronic equity markets collect, aggregate, and display pre-trade information to market participants. This pre-trade information takes the form of a quote that represents a single or an aggregate of same-priced principal or agency orders. A market, such as The Nasdaq Stock Market tm, also provides trading platforms through which market participants may trade securities in the marketplace.

### SUMMARY

According to an aspect of this invention, a multi-mechanism order scanning process includes a first interface process for monitoring the trading activity of securities traded on a first trading platform. A second interface process monitors the trading activity of securities traded on a second trading platform. A summarized display process, which is responsive to the first and second interface processes, provides a summarized display that itemizes at least a portion of the trading activity monitored on at least one of the trading platforms.

One or more of the following features may also be included. Additional interfaces are each configured to monitor the trading activity of securities traded on additional trading platforms. The first interface process is configured to receive attributable security interest messages that are indicative of the orders placed for securities traded on the first trading platform. The second interface process is configured to receive attributable security interest messages that are indicative of the orders placed for securities traded on the second trading platform.

A query process filters the attributable security interest messages received by the first and second interfaces in response to search criteria entered by a market participant. A security selection process allows the market participant to define one or more selected securities, such that orders concerning these selected securities are included in the summarized display. A platform selection process allows a market participant to define one or more trading platforms, such that orders placed on these trading platforms are included in the summarized display. A price selection process allows a market participant to define a price range, such that orders within this price range are included in the summarized display. A quantity selection process allows a market participant to define a quantity range, such that orders concerning a number of shares within this quantity range are included in the summarized display.

An order cancellation process allows a market participant to cancel an open order.

The above-described processes may also be implemented as a method or a sequence of instructions executed by a processor.

One or more advantages can be provided from the above. The market participant can quickly, easily, and simultaneously monitor the trading activity on multiple trading platforms. Further, the market participant can filter this trading activity in accordance with their needs and business interests. Additionally, since the market participant can easily cancel open orders that they placed, trade management is simplified.

### DESCRIPTION OF DRAWINGS

FIG. 1 is a block diagram of a multi-platform trading system including a multi-mechanism order scanning process;

FIG. 2 is a block diagram of the multi-mechanism order scanning process of FIG. 1;

FIG. 3 is a diagrammatic view of a summarized display generated by the multi-mechanism order scanning process of FIG. 2; and

FIG. 4 is a block diagram of a multi-mechanism order scanning method.

### DETAILED DESCRIPTION

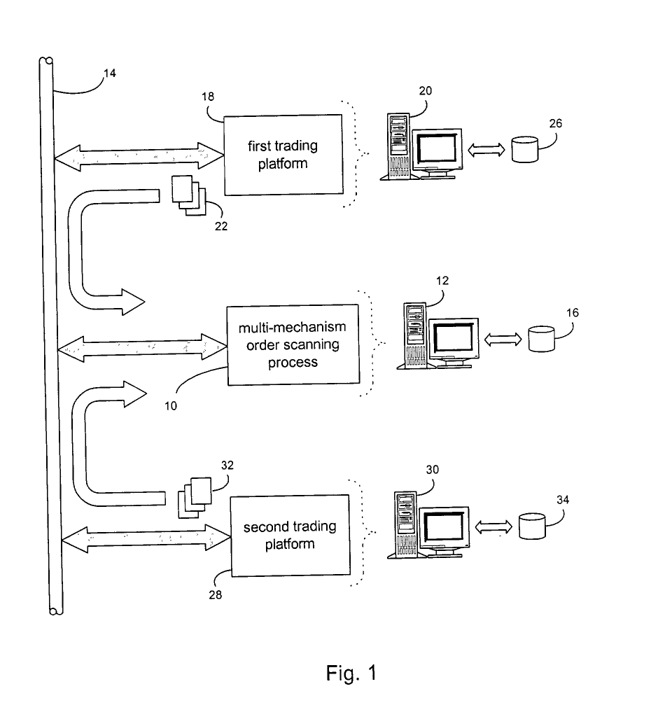

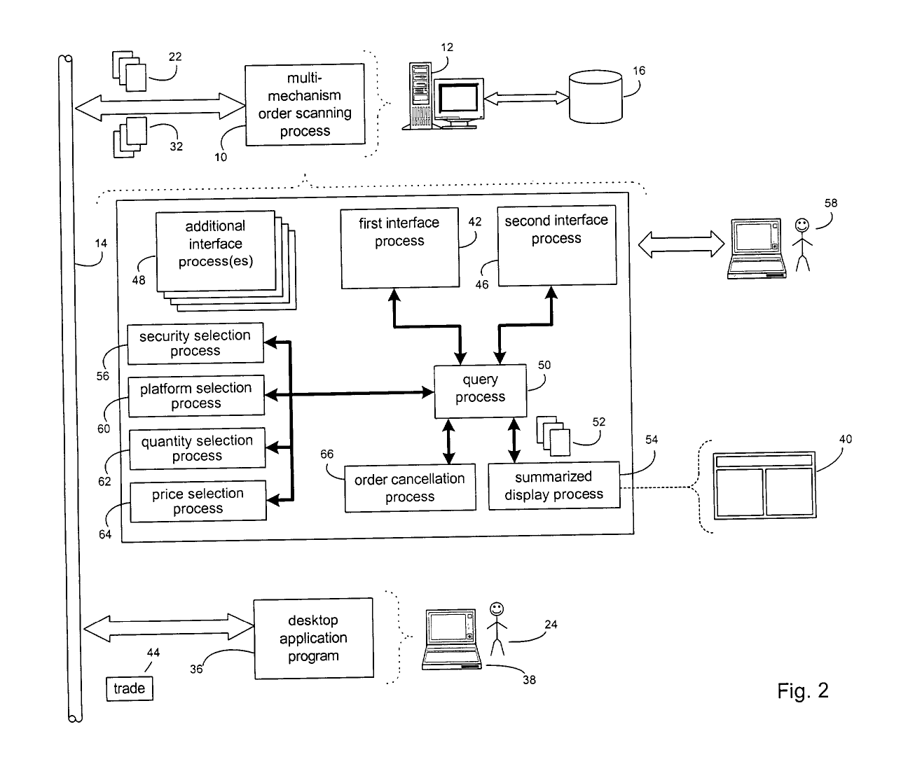

Referring to FIGS. 1 and 2, there is shown a multi-mechanism order scanning process 10. Process 10 resides on a server 12 that is connected to a distributed computing network 14 (e.g., the Internet, an intranet, a local area network, or some other form of network). Process 10 typically resides on a storage device 16 connected to server 12. Storage device 16 can be a hard disk drive, a tape drive, an optical drive, a RAID array, a random access memory (RAM), or a read-only memory (ROM), for example.

Computerized trading platform 18 (e.g., The Nasdaq Stock Market's SelectNet Trading System), which trades securities electronically and resides on server 20, processes attributable security interest messages 22. These messages, which are entered by market participants (e.g., market participant 24), concern a specific security sought for purchase or offered for sale on computerized trading platform 18. Server 20, which is also connected to distributed computing network 14, broadcasts messages 22 across network 14. Platform 18 typically resides on a storage device 26 connected to server 20. Storage device 26 can be a hard disk drive, a tape drive, an optical drive, a RAID array, a random access memory (RAM), or a read-only memory (ROM), for example. Additionally, computerized trading platform 18 stores all information relating to securities trades on storage device 26.

Computerized trading platform 28 (e.g., The Nasdaq Stock Market's Small Order Execution System), which trades securities electronically and resides on server 30, processes attributable security interest messages 32. These messages, which are also entered by market participants (e.g., market participant 22), concern a specific security sought for purchase or offered for sale on computerized trading platform 28. Server 30, which is also connected to distributed computing network 14, broadcasts messages 32 across network 14. Platform 28 typically resides on a storage device 34 connected to server 30. Storage device 34 can be a hard disk drive, a tape drive, an optical drive, a RAID array, a random access memory (RAM), or a read-only memory (ROM), for example. Additionally, computerized trading platform 28 stores all information relating to securities trades on storage device 26.

Market participant 24 typically accesses and uses computerized trading platforms 18, 28 and multi-mechanism order scanning process 10 via a desktop application 36 (e.g., Microsoft Internet Explorer™, Netscape Navigator™, the Nasdaq Workstation II™, a specialized desktop interface, etc.) residing on a computer 38, thus allowing market participant 24 to trade securities with other market participants (not shown).

Process 10 allows market participant 24 to monitor the trading activity of securities traded on either (or both) of the trading platforms 18, 28, by providing market participant 24 with a summarized display 40 (to be discussed below in greater detail), which is viewable on computer 38 and itemizes the trading activity occurring on these trading platforms. Typically, summarized display 40 is one screen in size, thus allowing market participant 24 to quickly get an overview of the trading activity of the various trading platforms without having to scroll through or toggle between multiple screens.

Process 10 includes a first interface process 42 that monitors the trading activity of securities traded on trading platform 18. As stated above, during the course of the trading day, market participants (e.g., market participant 24) trade securities on trading platform 18. When a market participant enters a trade (e.g., trade 44), a message 22 is generated concerning the security being traded. These messages 22, which are provided to multi-mechanism order scanning process 10, are typically “streamed” onto network 14. Hence, by monitoring this message stream, process 10 is informed of each trade occurring on trading platform 18.

Similarly, process 10 includes a second interface process 46 that monitors the trading activity of securities traded on trading platform 28. As with trading platform 18, during the course of the trading day, market participants (e.g., market participant 24) trade securities on trading platform 28. When a market participant enters a trade, a message 32 is generated concerning the security being traded. These messages 32 are also provided to process 10. Again, messages 32 are “streamed” onto network 14 and, by monitoring this message stream, process 10 is informed of each trade occurring on trading platform 28.

If process 10 is to monitor the trades occurring on additional trading platforms (not shown), additional interface processes 48 may be used to monitor such trading activities.

First and second interface processes 18, 28 provide messages 22, 32 to query process 50 which filters these attributable security interest messages 22, 32 in response to search criteria (e.g., security name, trading platform, share quantity, trading price range) entered by market participant 24. Query process 50, in turn, provides consolidated and filtered data 52 to summarized display process 54, which generates summarized display 40 (to be discussed below in greater detail).

As a message 22 is generated for each trade that occurs on trading platform 18, and a message 32 is generated for each trade that occurs on trading platform 28, it is foreseeable that market participant 22 would want to filter these messages streams so that summarized display 40 only includes entries for those trades that market participant 22 is interested in monitoring.

Query process 50 performs this filtering and allows market participant 22 to filter message streams 22, 32 into a manageable number of messages.

Query process 50 includes a security selection process 56 that allows the market participant 24 to define one or more selected securities (chosen from those traded on trading platforms 18, 28), such that orders concerning these selected securities are included in the summarized display 40. This selection may occur is several different ways and will vary depending on the manner in which process 56 is implemented and configured by administrator 58. For example, market participant 24 may select the security they wish to monitor via a dropdown menu that allows the market participant to scroll through a list of securities and select the one(s) they wish to monitor. This drop down menu may utilize ticker symbols or may list the full name of the issuer of the security. Alternatively, market participant 24 may wish to enter the security's ticker symbol directly, thus allowing for quicker selection.

Query process 50 also includes a platform selection process 60 that allows the market participant 24 to define one or more selected trading platforms (chosen from those that are monitored by process 10), such that orders placed on these selected trading platforms are included in the summarized display 40. Again, this selection may occur is several different ways and will vary depending on the manner in which process 60 is implemented and configured by administrator 58.

Additionally, query process 50 includes a quantity selection process 62 that allows the market participant 24 to define a quantity range (typically in shares), such that orders concerning a number of shares within the quantity range are included in the summarized display. This quantity range selection may occur is several different ways and will vary depending on the manner in which process 62 is implemented and configured by administrator 58. For example, market participant 24 may select the quantity range they wish to monitor via a drop-down menu that allows the market participant to scroll through a list of quantity ranges and select the quantity they wish to monitor. Alternatively, market participant 24 may be able to manually enter an upper limit and a lower limit. Additionally, market participant 24 may be able to enter a specific quantity (e.g., 1,000 shares). Therefore, for this example, the range would be a fixed share amount in which the upper limit is equal to the lower limit. Further, market participant 24 may be able to enter a wildcard descriptor (e.g., *) for either or both limits. Therefore, the range could be from negative infinity to positive infinity, resulting in all shares of a selected security (or any security) being displayed (regardless of their quantity).

Further, query process 50 includes a price selection process 64 for allowing a market participant 24 to define a price range, such that orders within the price range are included in the summarized display. This price range selection may occur is several different ways and will vary depending on the manner in which process 64 is implemented and configured by administrator 58. For example, market participant 24 may select the price range of securities they wish to monitor via a drop-down menu that allows the market participant to scroll through a list of price ranges and select the range they wish to monitor. Alternatively, market participant 24 may be able to manually enter an upper limit and a lower limit. Additionally, market participant 24 may be able to enter a specific price (e.g., $10). Therefore, for this example, the range would be a fixed dollar amount in which the upper limit is equal to the lower limit. Further, market participant 24 may be able to enter a wildcard descriptor (e.g., *) for either or both limits. Therefore, the range could be from negative infinity to positive infinity, resulting in all shares of the selected security being displayed (regardless of the offer/bid price).

Multi-mechanism order scanning process 10 includes an order cancellation process 66 that allows a market participant 24 to cancel any open order (i.e., an order that has not yet been filled) that the particular market participant 24 has placed. This is typically accomplished through summarized display process 40.

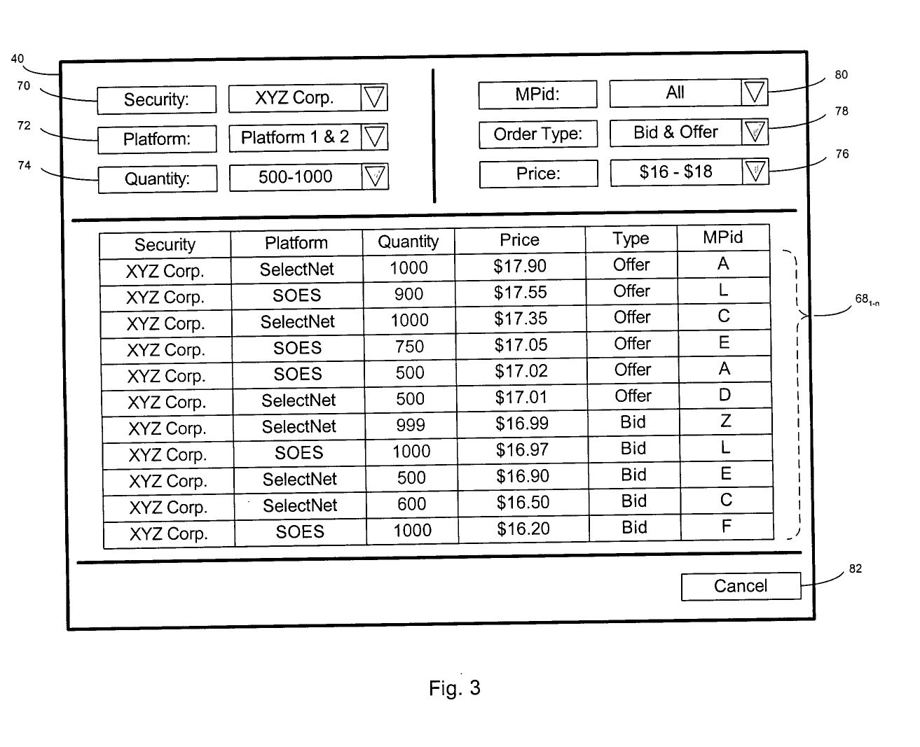

Referring to FIG. 3, summarized display 40, which is generated by summarized display process 54 (FIG. 2), includes various entries 68₁₋ₙ that are responsive to the search criteria entered by the market participant using query process 50 (FIG. 2). Entries 68₁₋ₙ are typically arranged in columns, such that each column has a heading (e.g., Security, Platform, Quantity, Price, Type, and MPid). Summarized display 40 typically includes, for example, pull down menus (e.g., 70, 72, 74, 76, 78, 80) that the market participant uses to define the search criteria for query process 50 (FIG. 2). For example, pull down menu 70 allows the market participant to define the security to be monitored for security selection process 56 (FIG. 2). Further, pull down menu 72 allows the market participant define the trading platform to be monitored for platform selection process 60 (FIG. 2). And pull down menu 74 allows the market participant to define the trade quantity to be monitored for quantity selection process 62 (FIG. 2). Additionally, pull down menu 76 allows the market participant to define the trade price to be monitored for price selection process 64 (FIG. 2).

As stated above, the market participant may be able to define other search criteria, such as: an order type 78, which defines whether to display bid-side entries and/or ask-side entries; and a market participant identifier (MPid) 80 which defines the market participant who placed the order.

As stated above, if the market participant chooses to cancel an open order that they placed, order cancellation process 66 (FIG. 1) allows the them to do so. Therefore, if the market participant chooses to cancel an open order, they can select the order they wish to cancel using a mouse (not shown) or a combination of keystrokes. Once the selection is made, the market participant would typically take some affirmative action to confirm the cancellation. An example of this affirmative action is “clicking” on the “cancel” button 82, thus confirming their desire to cancel the open order.

While the above specification defines two trading platforms, this is for illustrative purposes only, as the actual number of trading platforms monitored will vary depending on the specific application to which process 10 is applied.

While the share quantities described above are stated to be in units of shares, it is possible for these numbers to also represent groups of one-hundred shares (commonly referred to as “round lots”), or any other amount of shares.

While the search criteria described above is defined to include a limited selection of definable fields (namely Security, Platform, Quantity, Price, Type, and MPid, this is for illustrative purpose only, as the number and type of searchable fields will vary depending on the specific application to which process 10 is applied.

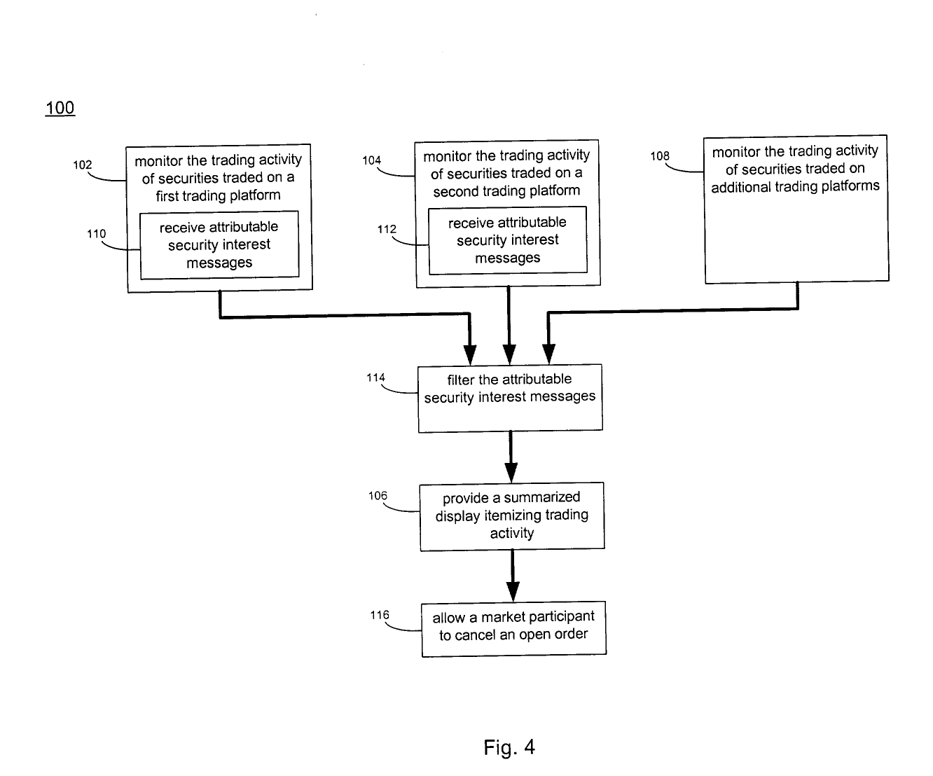

Referring to FIG. 4, there is shown a multi-mechanism order scanning method 100.

The trading activity of securities traded on a first trading platform is monitored 102 and the trading activity of securities traded on a second trading platform is also monitored 104. A summarized display is provided 106 that itemizes at least a portion of the trading activity monitored on at least one of these trading platforms. Additionally, the trading activity of securities traded on additional trading platforms may also be monitored 108.

Attributable security interest messages are received 110 that are indicative of the orders placed for securities traded on the first trading platform, and attributable security interest messages are received 112 that are indicative of the orders placed for securities traded on the second trading platform. The attributable security interest messages received are filtered 114 in response to search criteria entered by a market participant. A market participant is allowed 116 to cancel open orders.

The system described herein is not limited to the hardware embodiment described above; it may find applicability in any computing or processing environment. The system may be implemented in hardware, software, or a combination of the two. For example, the system may be implemented using circuitry, such as one or more of programmable logic (e.g., an ASIC), logic gates, a processor, and a memory.

The system may be implemented in computer programs executing on programmable computers that each includes a processor and a storage medium readable by the processor (including volatile and non-volatile memory and/or storage elements). Each such program may be implemented in a high-level procedural or object-oriented programming language to communicate with a computer system. However, the programs can be implemented in assembly or machine language. The language may be a compiled or an interpreted language.

Each computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the data framer interface. The system may also be implemented as a machine-readable storage medium, configured with a computer program, where, upon execution, instructions in the computer program cause a machine to operate to perform the functions of the system described above.

Embodiments of the system may be used in a variety of applications. Although the system is not limited in this respect, the system may be implemented with memory devices in microcontrollers, general purpose microprocessors, digital signal processors (DSPs), reduced instruction-set computing (RISC), and complex instruction-set computing (CISC), among other electronic components.

Embodiments of the system may also be implemented using integrated circuit blocks referred to as main memory, cache memory, or other types of memory that store electronic instructions to be executed by a microprocessor or store data that may be used in arithmetic operations.

A number of embodiments of the invention have been described. Nevertheless, it will be understood that various modifications may be made without departing from the spirit and scope of the invention.

What is claimed is:

1. A multi-mechanism order scanning process comprising:
a first interface process for monitoring the trading activity of securities traded on a first trading platform;
a second interface process for monitoring the trading activity of securities traded on a second trading platform; and
a summarized display process, responsive to the first and second interfaces processes, for providing a summarized display that itemizes at least a portion of the trading activity monitored on at least one of the trading platforms.

2. The multi-mechanism order scanning process of claim 1 further comprising one or more additional interfaces, each of which is configured to monitor the trading activity of securities traded on an additional trading platform.

3. The multi-mechanism order scanning process of claim 1 wherein the first interface process is configured to receive attributable security interest messages that are indicative of the orders placed for securities traded on the first trading platform, and the second interface process is configured to receive attributable security interest messages that are indicative of the orders placed for securities traded on the second trading platform

4. The multi-mechanism order scanning process of claim 3 further comprising a query process for filtering the attributable security interest messages received by the first and second interfaces in response to search criteria entered by a market participant.

5. The multi-mechanism order scanning process of claim 4 wherein the query process includes a security selection process for allowing the market participant to define one or more selected securities, such that orders concerning these one or more selected securities are included in the summarized display.

6. The multi-mechanism order scanning process of claim 4 wherein the query process includes a platform selection process for allowing a market participant to define one or more trading platforms, such that orders placed on these one or more trading platforms are included in the summarized display.

7. The multi-mechanism order scanning process of claim 4 wherein the query process includes a price selection process for allowing a market participant to define a price range, such that orders within the price range are included in the summarized display.

8. The multi-mechanism order scanning process of claim 4 wherein the query process includes a quantity selection process for allowing a market participant to define a quantity range, such that orders concerning a number of shares within the quantity range are included in the summarized display.

9. The multi-mechanism order scanning process of claim 3 further comprising an order cancellation process for allowing a market participant to cancel an open order.

10. A multi-mechanism order scanning method comprising:
monitoring the trading activity of securities traded on a first trading platform;
monitoring the trading activity of securities traded on a second trading platform; and
providing a summarized display that itemizes at least a portion of the trading activity monitored on at least one of the trading platforms.

11 The multi-mechanism order scanning method of claim 10 further comprising monitoring the trading activity of securities traded on one or more additional trading platforms.

12. The multi-mechanism order scanning method of claim 10 wherein:
monitoring the trading activity of securities traded on a first trading platform includes receiving attributable security interest messages that are indicative of the orders placed for securities traded on the first trading platform; and
monitoring the trading activity of securities traded on a second trading platform includes receiving attributable security interest messages that are indicative of the orders placed for securities traded on the second trading platform

13. The multi-mechanism order scanning method of claim 12 further comprising filtering the attributable security interest messages received in response to search criteria entered by a market participant.

14. The multi-mechanism order scanning method of claim 13 wherein filtering the attributable security interest messages includes allowing the market participant to define one or more selected securities, such that orders concerning these one or more selected securities are included in the summarized display.

15. The multi-mechanism order scanning method of claim 13 wherein filtering the attributable security interest messages includes allowing a market participant to define one or more trading platforms, such that orders placed on these one or more trading platforms are included in the summarized display.

16. The multi-mechanism order scanning method of claim 13 wherein filtering the attributable security interest messages includes allowing a market participant to define a price range, such that orders within the price range are included in the summarized display.

17. The multi-mechanism order scanning method of claim 13 wherein filtering the attributable security interest messages includes allowing a market participant to define a quantity range, such that orders concerning a number of shares within the quantity range are included in the summarized display.

18. The multi-mechanism order scanning method of claim 12 further comprising allowing a market participant to cancel an open order.

19. A computer program product residing on a computer readable medium having a plurality of instructions stored thereon which, when executed by the processor, cause that processor to::
monitor the trading activity of securities traded on a first trading platform;
monitor the trading activity of securities traded on a second trading platform; and
provide a summarized display that itemizes at least a portion of the trading activity monitored on at least one of the trading platforms.

20 The computer program product of claim 19 further comprising instructions to monitor the trading activity of securities traded on one or more additional trading platforms.

21. The computer program product of claim 19 wherein:
instructions to monitor the trading activity of securities traded on a first trading platform further includes instructions to receive attributable security interest messages that are indicative of the orders placed for securities traded on the first trading platform; and
instructions to monitor the trading activity of securities traded on a second trading platform further includes instructions to receive attributable security interest messages that are indicative of the orders placed for securities traded on the second trading platform

22. The computer program product of claim 21 further comprising instructions to filter the attributable security interest messages received in response to search criteria entered by a market participant.

23. The computer program product of claim 22 wherein instructions to filter the attributable security interest messages further includes instructions to allow the market participant to define one or more selected securities, such that orders concerning these one or more selected securities are included in the summarized display.

24. The computer program product of claim 22 wherein instructions to filter the attributable security interest messages further includes instructions to allow a market participant to define one or more trading platforms, such that orders placed on these one or more trading platforms are included in the summarized display.

25. The computer program product of claim 22 wherein instructions to filter the attributable security interest messages further includes instructions to allow a market participant to define a price range, such that orders within the price range are included in the summarized display.

26. The computer program product of claim 22 wherein instructions to filter the attributable security interest messages further includes instructions to allow a market participant to define a quantity range, such that orders concerning a number of shares within the quantity range are included in the summarized display.

27. The computer program product of claim 21 further comprising instructions to allow a market participant to cancel an open order.
